(19) United States
(12) Patent Application Publication
(10) Pub. No.: US 2025/0384418 A1
(43) Pub. Date: Dec. 18, 2025

(54) Systems and Methods for Settlement Interfaces in Cellular Networks Using Blockchain Technology

(71) Applicant: Nova Labs, Inc., San Francisco, CA (US)

(72) Inventors: Joseph Padden, Boulder, CO (US); Boris Renski, Denver, CO (US); Arsenii Oganov, Kyiv (UA); Dmytro Tsapko, Kyiv (UA); Serhii Tukalo, Kyiva (UA); Roman Skochypets, Kyiv (UA)

(21) Appl. No.: 19/239,752

(22) Filed: Jun. 16, 2025

Related U.S. Application Data
(60) Provisional application No. 63/660,642, filed on Jun. 17, 2024.

(51) Int. Cl. G06Q 20/16; G06Q 20/38

(52) U.S. Cl. CPC G06Q 20/16; G06Q 20/381; G06Q 20/389

(57) ABSTRACT

The present system relates to settling transactions in a network environment using blockchain technology. The system comprises multiple network operator domains, each with network infrastructure components. A first operator domain includes a gateway for managing device connections and a blockchain interface for managing transaction settlements. A settlement management domain maintains transaction records for multiple network operators. The blockchain is configured to record and settle transactions. The system facilitates network operator provisioning, transaction initiation, and settlement. The gateway manages device connections using WiFi, 4G, 5G, or 6G technologies, and the blockchain interface interacts with the blockchain for real-time settlement of transactions. The settlement management domain uses an Settlement Service API for real-time reporting and settlement verification.

### PRIORITY

This disclosure claims the benefit of U.S. provisional application No. 63/660,642, which is herein incorporated by reference in its entirety.

### FIELD OF INVENTION

The disclosure generally relates to the field of wireless network technology. In particular, the disclosure relates to the integration of blockchain technology within a network environment (e.g., a broadband or cellular network environment, a local network environment, such as WiFi, or the like).

### SUMMARY OF INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Example aspects as disclosed herein provide a system and method for settling transactions in a network environment using blockchain technology. This may include the use of blockchain technology for real-time accounting and settlement of data usage in wireless networks such as 4G, 5G, 6G (e.g., a broadband wireless network or cellular network environment), local networks such a WiFi, and the implementation of online charging systems (OCS) and other network infrastructure components for managing device connections and transaction settlements.

The system may include multiple network operator domains, each with its own network infrastructure components. For example, a first operator domain may include a gateway for managing device connections and a blockchain interface for managing transaction settlements. The system may further include a settlement management domain for maintaining transaction records for multiple network operators. A blockchain network (e.g., the Helium blockchain, Solana, or any other suitable blockchain) may be configured to record and settle transactions, facilitating network operator provisioning, transaction initiation, and settlement.

In one aspect, the gateway in the first operator domain may manage device connections using technologies such as WiFi, 4G, 5G, or 6G. The blockchain interface in the first operator domain may interact with the blockchain for real-time settlement of transactions. The settlement management domain may maintain transaction records for multiple network operators using a Settlement Service Application Programming Interface (API) to facilitate real-time reporting and settlement verification. The blockchain may ensure secure and transparent settlement of transactions.

In another aspect, the system may facilitate network operator provisioning through a network operator portal. Transaction initiation may be conducted via an Enterprise Resource Planning system. The system may also facilitate transaction tracking for each network operator and settlement management through a Settlement Management API. The system may further facilitate the allocation of transaction records to a state channel in the blockchain.

In yet another aspect, a method for settling transactions involves converting monetary value into a cryptocurrency (e.g., Helium Network Tokens, or HNT), initiating transactions for a first operator domain, interacting with the blockchain through a blockchain interface to manage transaction settlements, maintaining transaction records for multiple network operators in a settlement management domain, recording and settling transactions through the blockchain, and facilitating network operator provisioning, transaction initiation, and settlement.

Other aspects that could form the basis of separate new independent claims include, but are not limited to, systems and methods for managing transaction settlements in other types of wireless network environments (e.g., local network environments such as WiFi) using different types of blockchain technology, systems and methods for settling transactions using different types of digital currencies, and systems and methods for settling transactions using different types of settlement management domains.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a system architecture and process flow for managing data credits within a mobile network operator environment, in accordance with one or more aspects described herein.

FIG. 2 depicts a block diagram of the integration interfaces between various domains involved in the cellular Blockchain Accounting Flow, in accordance with one or more aspects described herein.

FIG. 3 shows a secure communication flow and a process for managing keys between various components involved in the cellular Blockchain Accounting Flow, in accordance with one or more aspects described herein.

FIG. 4 provides a detailed breakdown of the structure and components involved in the transfer of TAP3 files, which are associated with the accounting and settlement processes in mobile networks, in accordance with one or more aspects described herein

FIG. 5 depicts a block diagram illustrating the flow of balance management and data credit allocation within the Blockchain managed and OCS managed domains, in accordance with one or more aspects described herein.

FIG. 6 depicts an illustrative flowchart in accordance with one or more aspects described herein.

### DETAILED DESCRIPTION

Broadband wireless networks (i.e., cellular networks), such as 4G, 5G, and future 6G networks, are designed to support high-speed data transmission, allowing users to consume large volumes of data. These networks typically include various infrastructure components, such as gateways and online charging systems (OCS), to manage device connections and transaction settlements.

In traditional cellular networks, the accounting and settlement of data usage are typically handled by the network operator. The operator maintains a record of each user's data consumption and charges the user accordingly. This process involves complex systems and protocols to accurately track and bill for data usage.

Blockchain technology, on the other hand, provides a decentralized and transparent method for recording and verifying transactions. Each transaction is recorded in a block and added to a chain of previous transactions, creating a permanent and unalterable record. This technology has been widely adopted in various industries for its potential to improve transparency, security, and efficiency in transaction management.

However, integrating blockchain technology into cellular networks (or other wireless networks, such as Wi-Fi networks) presents several challenges. One of the primary challenges is the high volume and speed of data flowing in these networks and the dynamic nature of moving cellular devices traversing multiple wireless networks. Traditional blockchain systems may not be able to handle such large volumes of data efficiently. Furthermore, the granularity of blockchain accounting, which refers to the level of detail in the transaction records, may not be sufficient for accurately tracking data usage in cellular networks.

Another challenge is the signaling overhead associated with blockchain accounting. In a blockchain system, each transaction requires a series of message exchanges to verify and record the transaction. This signaling process can introduce additional latency and overhead, which may negatively impact the performance of the network.

Moreover, the use of blockchain technology in cellular networks requires modifications to existing network infrastructure and protocols. For instance, the online charging system (OCS) in a cellular network, which traditionally manages quota and real-time session management and accounting, may require modifications to support blockchain-based accounting and settlement.

Despite these challenges, the integration of blockchain technology into cellular networks (or any other type of network environment) holds promise for improving the transparency and efficiency of data usage accounting and settlement. There is a clear demand for systems and methods that can effectively integrate blockchain technology into wireless networks while addressing the aforementioned challenges.

The following description sets forth exemplary aspects of the present disclosure. It should be recognized, however, that such description is not intended as a limitation on the scope of the present disclosure. Rather, the description also encompasses combinations and modifications to those exemplary aspects described herein.

Aspects of the disclosure provide a system and method for settling transactions in a network environment using blockchain technology. The system may include multiple network operator domains, each with its own network infrastructure components. A first operator domain may include a gateway for managing device connections and a blockchain interface for managing transaction settlements. A settlement management domain may maintain transaction records for multiple network operators. The system may also include a blockchain configured to record and settle transactions. In this manner, the system may improve how networks (e.g., a cellular network, local network (WiFi), or the like) transparently record and settle transactions related to data usage by devices connected to the network. Advantageously, network traffic associated with a network may be offloaded to one or more operator domains, thereby preventing network congestion during times of excess network usage.

In some aspects, the system may be designed to facilitate network operator provisioning, transaction initiation, and settlement. The gateway in the first operator domain may manage device connections using various technologies, such as WiFi, 4G, 5G, or 6G. The blockchain interface in the first operator domain may interact with the blockchain to manage transaction settlements in real-time. The settlement management domain may maintain transaction records for multiple network operators using a Settlement Service API, facilitating real-time reporting and settlement verification.

A blockchain network (e.g., the Helium blockchain, Solana, or the like) may ensure secure and transparent settlement of transactions. The system may also facilitate cellular network operator provisioning through a network operator portal and transaction initiation via an Enterprise Resource Planning system. The system may further facilitate transaction tracking for each cellular network operator and settlement management through a Settlement Management API. The system may also facilitate the allocation of transaction records to a state channel in the blockchain.

This system and method may provide a robust and efficient solution for real-time accounting and settlement of data usage in networks such as 4G, 5G, and 6G. The use of blockchain technology may ensure transparency and security, making it a viable solution for managing high volumes of data and transactions in cellular network environments.

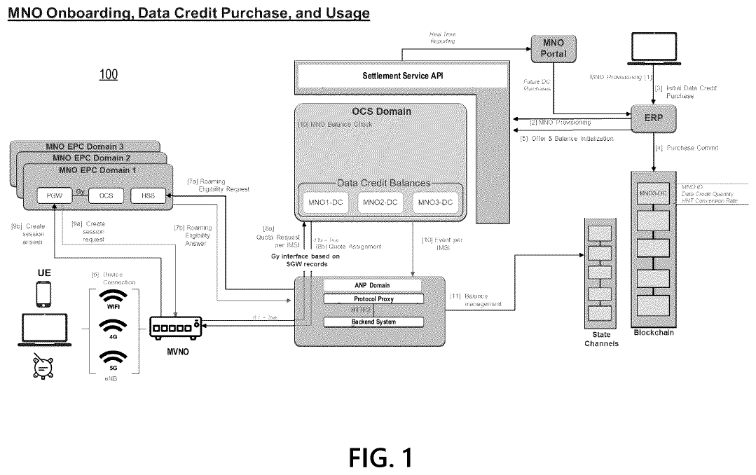

Referring to FIG. 1, system 100 depicts a system architecture and process flow for managing data credits within a cellular network operator environment. As shown by FIG. 1, the system 100 includes a plurality of cellular network operator domains, each domain including network infrastructure components. In some aspects, these components may include a Packet Gateway (PGW), an Online Charging System (OCS), and a Home Subscriber Server (HSS). These components may interact with a mobile virtual network operator (MVNO) (e.g., a FreedomFi Gateway (GW)) to manage user sessions. In other aspects, a network operator environment may use Wi-Fi-based components such as Authentication, Authorization, and Accounting (AAA) servers and/or a (Remote Authentication Dial-In User Service (RADIUS) protocol to manage user sessions, without departing from the scope of the disclosure.

As an example, in a first operator domain, a gateway may be included for managing device connections and a blockchain interface (e.g., a Gy interface based on Service Gateway (SGW) records or a RADIUS connection based on AAA records) for managing transaction settlements. The gateway may manage device connections using various technologies, such as WiFi, 4G, or 5G. The blockchain interface in the first operator domain may interact with the blockchain to manage transaction settlements in real-time.

The system 100 may also include a settlement management domain for maintaining transaction records for multiple cellular network operators. The settlement management domain may maintain transaction records using a Settlement Service API to facilitate real-time reporting and balance checks. The Settlement Service API may hide vendor specifics, providing a unified interface for managing transaction records.

The system 100 may be configured to facilitate cellular network operator provisioning, transaction initiation, and settlement. Cellular network operator provisioning may be facilitated through a network operator portal (e.g., a Mobile Network Operator (MNO) Portal). Transaction initiation may be conducted via an Enterprise Resource Planning (ERP) system. The system may also facilitate transaction tracking for each cellular network operator and settlement management through a Settlement Management API.

The system 100 may also facilitate the allocation of transaction records to a state channel in the blockchain. The state channel may record and settle transactions, ensuring secure and transparent accounting. The allocation of transaction records to the state channel may be facilitated by a Helium Handler in the Access Network Provider (ANP) domain.

In some cases, the system 100 may include additional components or features to further enhance the management of data credits within a cellular network operator environment. For example, the system 100 may include additional interfaces, protocols, or algorithms for managing data credits, transaction settlements, or other aspects of the system without departing from the scope of the disclosure.

Continuing with the description of FIG. 1, the process flow for managing data credits within a cellular network operator environment may involve several steps. These steps include MNO provisioning, initial data credit purchase, purchase commit, offer and balance initialization, device connection, roaming eligibility request and answer, quota request and assignment, session creation request and answer, event, and balance management.

In some aspects, the gateway in the first operator domain may be configured to manage device connections using various technologies. These technologies may include, but are not limited to, WiFi, 4G, 5G, or 6G. The specific technology used may depend on the capabilities of the devices connecting to the network and the network infrastructure itself. While the names of the components servicing each function may differ between network types (differ, e.g., between cellular networks and Wi-Fi networks), the functions performed and the discussion herein may be similarly performed for each network type without departing from the scope of the disclosure.

The blockchain interface in the first operator domain may interact with the blockchain to manage transaction settlements in real-time. This real-time interaction allows for immediate accounting and settlement of data usage, providing a more efficient and transparent process compared to traditional settlement methods.

The settlement management domain may maintain transaction records for multiple cellular network operators. In some cases, this domain may use a Settlement Service API (e.g., an Enterprise Service Bus (ESB)) to facilitate real-time reporting and balance checks. The Settlement Service API may hide vendor specifics, providing a unified interface for managing transaction records across multiple cellular network operators.

The system may also facilitate network operator provisioning through a network operator portal (e.g., the MNO Portal). This portal may provide a user-friendly interface for cellular network operators to manage their provisioning processes. The portal may also provide tools and resources to assist network operators in managing their network infrastructure and services.

Transaction initiation may be conducted via an Enterprise Resource Planning (ERP) system. The ERP system may provide a centralized platform for managing business processes, including transaction initiation. The ERP system may also provide tools and resources for managing financial transactions, inventory management, and other business processes.

The system may further facilitate transaction tracking for each network operator. This may involve tracking the amount of data used by each operator's subscribers, the amount of data credits consumed, and other relevant information. This information may be used for billing purposes, network management, and/or other similar purposes.

Finally, the system may facilitate balance management through a Settlement Management API. This API may provide a programmable interface for managing balances, conducting transactions, and performing other balance management tasks. The API may also provide tools and resources for integrating the balance management functionality with other systems and applications.

In some aspects, the system may facilitate network operator provisioning through a network operator portal. This portal may provide a user-friendly interface for network operators to manage their provisioning processes. The portal may also provide tools and resources to assist network operators in managing their network infrastructure and services.

In some cases, the system may include additional components or features to further enhance the management of data credits within a network operator environment. For example, the system may include additional interfaces, protocols, or algorithms for managing data credits, transaction settlements, or other aspects of the system without departing from the scope of the disclosure.

In some cases, the initiation of transactions for the first operator domain may be verified. This verification may involve comparing the initiated transactions with a predetermined threshold. If the initiated transactions exceed the threshold, the system may decline the transactions. If the initiated transactions do not exceed the threshold, the system may approve the transactions. For example, when a user session is initiated the network (e.g., a cellular network, a Wi-Fi network, or the like) may need to decide how much data usage to allow for the user session before further data usage requests may be made, which may be referred to as a quota. For example, a system that manages the quota and periodic reporting of quota consumption is called an OCS in cellular networks and is an AAA server in Wi-Fi networks. In both instances, a mid-session or interim usage report may be periodically sent to inform a governing service of the current usage in a given session.

The settlement management domain may maintain transaction records for multiple network operators. In some cases, these transaction records may be updated in real-time. This real-time updating may allow for more accurate and up-to-date tracking of transactions and balances.

In some aspects, the network operator may be registered with the first operator domain for provisioning. This registration may involve providing the network operator with access to the network operator portal and other resources. The registration may also involve setting up an account for the network operator in the settlement management domain.

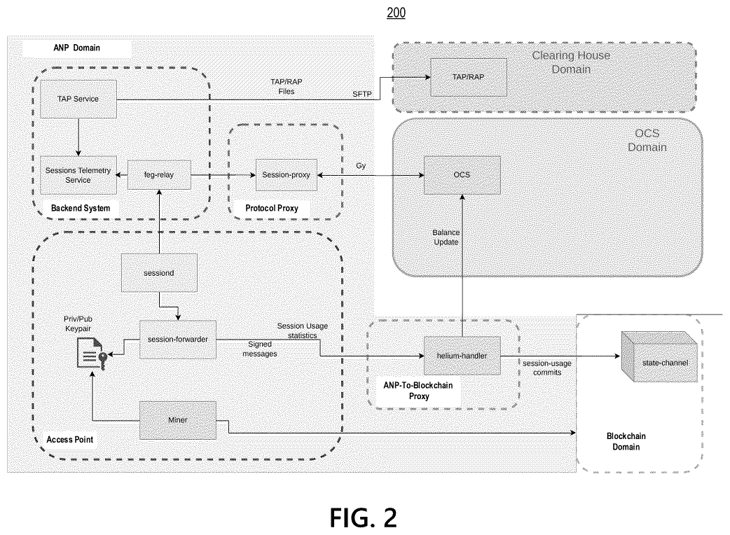

Referring to FIG. 2, diagram 200 depicts integration interfaces between the ANP domain, Clearing House domain, OCS domain, and blockchain domain (e.g., the Helium blockchain). As shown by the diagram 200, the ANP domain includes several components, such as the Transferred Account Procedures (TAP) Service, Sessions Telemetry Service, sessiond component, and the Miner. The TAP Service may connect to the Clearing House domain via an interface transport protocol (e.g., Secure File Transfer Protocol (SFTP)) for TAP/RAP file transfers. The Sessions Telemetry Service may communicate with a Protocol Proxy, such as, for example, a feg-relay (e.g., a Federated Edge Gateway), which in turn may connect to the Session-proxy using the Gy protocol. The sessiond component may send session statistics to the session-forwarder, which may forward signed messages to the Miner. The Miner may then send session usage statistics to the helium-handler in the ANP-to-Blockchain Proxy, which commits session usage to the state-channel in the blockchain domain. The OCS in the OCS domain may receive balance updates from the helium-handler.

In some aspects, the TAP Service may facilitate the transfer of TAP/RAP files between the ANP domain and the Clearing House domain. This transfer may be conducted via SFTP, providing a secure and efficient method for transferring files. The TAP/RAP files may contain information related to transactions, such as transaction records, transaction details, and/or other relevant information. In some cases, the Clearing House may be used to reconcile data associated with the TAP/RAP files, in order to maintain an accurate record of the data. Although TAP/RAP files generally refer to cellular networks, in the case of Wi-Fi networks, Usage Data Records (UDRs) may contain similar information (e.g., user IDs, radio IDs, Timestamps, usage uplink, usage downlink, class of data, etc) and be similarly used to reconcile and maintain an accurate record of the data without departing from the scope of the disclosure.

The Sessions Telemetry Service may communicate with the Protocol Proxy using various protocols, such as the Gy protocol. The Protocol Proxy may then connect to the Session-proxy, facilitating the exchange of information between the Sessions Telemetry Service and the Session-proxy. This exchange of information may include session statistics, transaction records, and other relevant data.

The sessiond component may send session statistics to the session-forwarder. These session statistics may include information related to the usage of sessions, such as the amount of data used, the duration of the session, and other relevant information. The session-forwarder may then forward these signed messages to the Miner.

The Miner may send session usage statistics to the helium-handler in the ANP-to-Blockchain Proxy. These session usage statistics may include information related to the usage of sessions, such as the amount of data used, the duration of the session, and other relevant information. The helium-handler may then commit this session usage to the state-channel in the blockchain domain.

The OCS in the OCS domain may receive balance updates from the helium-handler. These balance updates may include information related to the balances of various entities, such as cellular network operators, subscribers, and other relevant entities. The OCS may use this balance update information to manage and maintain the balances of these entities.

In some cases, the system may include additional components or features to further enhance the management of data credits within a cellular network operator environment. For example, the system may include additional interfaces, protocols, or algorithms for managing data credits, transaction settlements, or other aspects of the system.

With continuing reference to FIG. 2, the integration interfaces between the ANP domain, Clearing House domain, OCS domain, and blockchain domain are depicted. In the ANP domain, the session-forwarder manages session statistics. The session-forwarder may receive session statistics from the sessiond component and forward these signed messages to the Miner. The Miner, in turn, may send session usage statistics to the helium-handler in the ANP-to-Blockchain Proxy. The helium-handler then commits this session usage to the state-channel in the blockchain domain.

In some aspects, the session-forwarder may operate within a secure boot protected environment, ensuring the integrity and authenticity of the messages it forwards. The session-forwarder may use a Key Pair (e.g., a private/public keypair) for signing messages, which may further enhance the security of the communication.

The Miner, which may be a part of the ANP domain, may receive signed messages from the session-forwarder and forward these messages to the helium-handler. The Miner may trust the session-forwarder due to the secure boot protected environment in which the session-forwarder operates.

The helium-handler, which may reside in the ANP-to-Blockchain Proxy, may receive session usage statistics from the Miner and may commit this session usage to the state-channel in the blockchain domain. The helium-handler may interact with the blockchain through a blockchain interface to manage transaction settlements. The helium-handler may also receive balance updates from the OCS in the OCS domain.

In some cases, the helium-handler may update the state-channel with signed data usage received from the Miner. This update may be performed periodically or in response to specific events or triggers. The updated state-channel may then be used to record and settle transactions in the blockchain domain.

In some aspects, the helium-handler may interact with the OCS to receive balance updates. These balance updates may include information related to the balances of various entities, such as cellular network operators, subscribers, and other relevant entities. The OCS may use this balance update information to manage and maintain the balances of these entities.

In some cases, the system may include additional components or features to further enhance the management of data credits within a cellular network operator environment. For example, the system may include additional interfaces, protocols, or algorithms for managing data credits, transaction settlements, or other aspects of the system without departing from the scope of the disclosure.

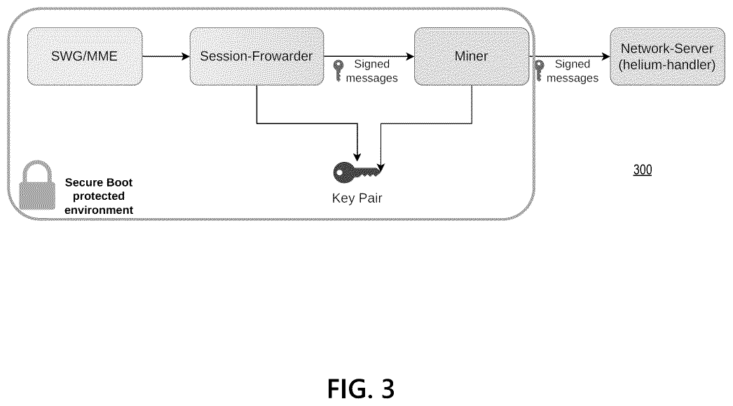

Referring to FIG. 3, diagram 300 depicts the secure communication flow and the process of managing keys between various components involved in the cellular Blockchain Accounting Flow. As shown by the diagram 300, the process begins with the Serving Gateway/Mobility Management Entity (SWG/MME), which may initiate the communication by sending messages to the Session-Forwarder. The Session-Forwarder, which may operate in a secure boot protected environment, may act as an intermediary and may forward these signed messages to the Miner. The Miner may then send signed messages to the Network-Server (helium-handler). Additionally or alternatively, the miner may be combined with the Session-Forwarder and perform similar functions as described herein without departing from the scope of the disclosure.

In some aspects, the Session-Forwarder may operate within a secure boot protected environment, ensuring the integrity and authenticity of the messages it forwards. The Session-Forwarder may use a Key Pair (e.g., a private/public key pair) for signing messages, further enhancing the security of the communication. This secure environment and the use of a Key Pair for signing messages may ensure that all software components loaded are verified and trusted, providing a secure communication flow between the SWG/MME, Session-Forwarder, Miner, and Network-Server. This secure communication flow is particularly relevant in the context of MNO provisioning, where the integrity and authenticity of the communication are important.

The Miner, which may be a part of the ANP domain (FIG. 2), may receive signed messages from the Session-Forwarder and may forward these messages to the helium-handler. The Miner may trust the Session-Forwarder due to the secure boot protected environment in which the Session-Forwarder operates. This trust relationship between the Miner and the Session-Forwarder may ensure that the Miner can reliably receive and process the signed messages from the Session-Forwarder.

The helium-handler, which may reside in the ANP-to-Blockchain Proxy, may receive session usage statistics from the Miner and may commit this session usage to the state-channel in the blockchain domain. The helium-handler may interact with the blockchain through a blockchain interface to manage transaction settlements. The helium-handler may also receive balance updates from the OCS in the OCS domain.

In some cases, the helium-handler may update the state-channel with signed data usage received from the Miner. This update may be performed periodically or in response to specific events or triggers. The updated state-channel may then be used to record and settle transactions in the blockchain.

In some aspects, the helium-handler may interact with the OCS (FIG. 2) to receive balance updates. These balance updates may include information related to the balances of various entities, such as cellular network operators, subscribers, and other relevant entities. The OCS may use this balance update information to manage and maintain the balances of these entities.

In some cases, the system may include additional components or features to further enhance the management of data credits within a network operator environment. For example, the system may include additional interfaces, protocols, or algorithms for managing data credits, transaction settlements, or other aspects of the system without departing from the scope of the disclosure.

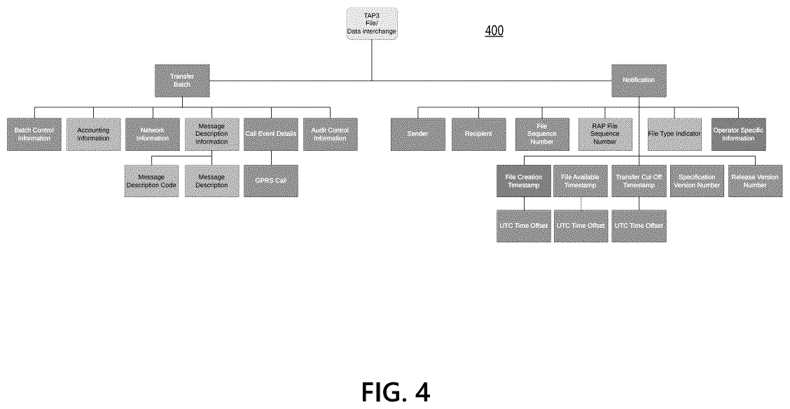

Referring to FIG. 4, diagram 400 depicts the structure and components of the TAP3 File/Data Interchange process. Although FIG. 4 describes an example of consolidated usage records (e.g., TAP3 files) in a cellular network environment, similar records in a Wi-Fi network (e.g., UDRs) may be used to perform similar functions as described herein without departing from the scope of the disclosure. As shown by the diagram 400, the process is organized into several sections, each representing different types of information contained within a TAP3 file. At the top, the central element is the Transfer Batch, which branches into various categories of information. These categories may include Batch Control Information, Accounting Information, Network Information, and Message Description Information. The Message Description Information may further be subdivided into Message Description Code and Message Description. The Call Event Details section specifically highlights GPRS Call data, which may indicate the type of call event details recorded.

The Audit Control Information section may be divided into Sender, Recipient, and File Sequence Number, with further details such as File Creation Timestamp, File Available Timestamp, and UTC Time Offset for both timestamps. This structure may ensure that all the requisite data for tracking and validating roaming subscriber activities are recorded and organized.

In some aspects, the Transfer Batch may serve as the central element in the TAP3 File/Data Interchange process. The Transfer Batch may contain various categories of information, such as Batch Control Information, Accounting Information, Network Information, and Message Description Information. Each category of information may include specific data related to the roaming subscriber activities, such as call event details, network information, and other relevant data.

The Call Event Details section may specifically highlight General Packet Radio Service (GPRS) Call data. This data may include information related to the type of call event, such as the duration of the call, the amount of data used during the call, and other relevant information. This information may be used for tracking and validating roaming subscriber activities, ensuring accurate and transparent accounting of data usage.

The Notification section may include Sender, Recipient, and File Sequence Number, along with additional details such as File Creation Timestamp, File Available Timestamp, and Coordinated Universal Time (UTC) Time Offset for both timestamps, and/or other similar information. This information may be used for auditing purposes, ensuring the integrity and accuracy of the data contained within the TAP3 file.

In some cases, the TAP3 File/Data Interchange process may include additional components or features to further enhance the management of data credits within a cellular network operator environment. For example, the process may include additional interfaces, protocols, or algorithms for managing data credits, transaction settlements, or other aspects of the process without departing from the scope of the disclosure.

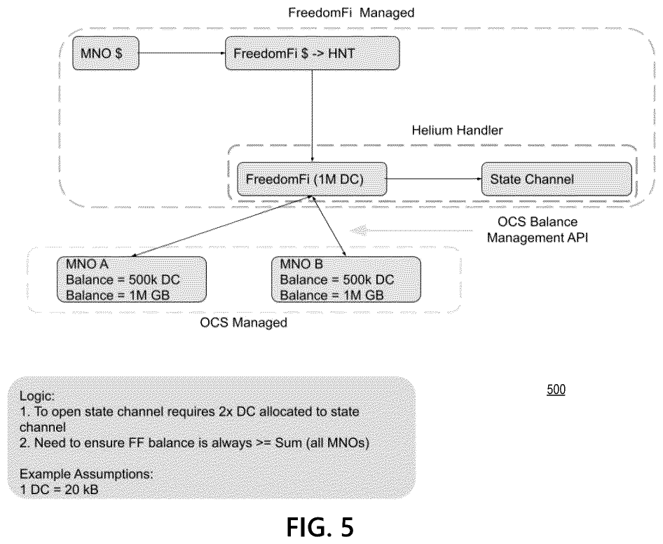

Referring to FIG. 5, diagram 500 depicts the flow of balance management and data credit allocation within the FreedomFi managed and OCS managed domains. As shown by the diagram 500, the process may begin with the conversion of monetary value into a digital currency, such as Helium Network Tokens (HNT). This conversion may be facilitated by a digital currency exchange platform, which may provide real-time exchange rates between the monetary value and the HNT. The converted HNT is then allocated to FreedomFi, resulting in an allocation of 1 million Data Credits to FreedomFi (1M DC).

In some aspects, the allocation of Data Credits to FreedomFi may be managed by the Helium Handler. The Helium Handler may interact with the blockchain to manage the allocation of Data Credits. The allocated Data Credits may then be used to facilitate transactions within the cellular network operator environment.

The system may also facilitate the interaction between the FreedomFi balance and the MNO balances through the OCS Balance Management API. The OCS Balance Management API may provide a programmable interface for managing balances, conducting transactions, and performing other balance management tasks. The API may also provide tools and resources for integrating the balance management functionality with other systems and applications.

In some cases, the initiation of transactions for the first operator domain may be verified. This verification may involve comparing the initiated transactions with a predetermined threshold. If the initiated transactions exceed the threshold, the system may decline the transactions. If the initiated transactions do not exceed the threshold, the system may approve the transactions.

The system may also facilitate the receipt of a transaction request from the cellular network operator and the deduction of the corresponding amount of Helium Network Tokens from the cellular network operator's account for transaction initiation. This process may involve verifying the availability of sufficient Helium Network Tokens in the cellular network operator's account, deducting the corresponding amount of Helium Network Tokens, and updating the cellular network operator's account balance accordingly.

In some aspects, the system may include additional components or features to further enhance the management of data credits within a cellular network operator environment. For example, the system may include additional interfaces, protocols, or algorithms for managing data credits, transaction settlements, or other aspects of the system without departing from the scope of the disclosure.

Although the discussion with respect to FIG. 5 describes an example of balance management and data credit allocation using FreedomFi, other Access Network Providers (ANPs) may be used without departing from the scope of the disclosure. Additionally or alternatively, other digital currencies instead of Helium Network Tokens may be used without departing from the scope of the disclosure.

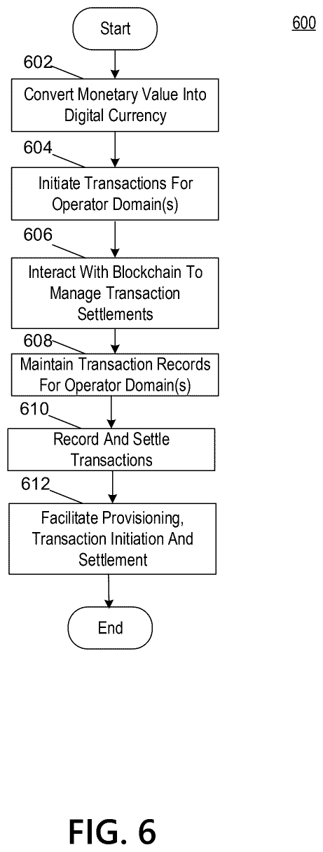

Reference to FIG. 6, flowchart 600 depicts an exemplary method according to one or more aspects described herein. In some cases, one or more of the steps depicted by the flowchart 600 may be implemented and/or performed by the systems described with reference to one or more of FIGS. 1-5. At step 602, monetary value may be converted into a digital currency. For example, converting monetary value into Helium Network Tokens may include using a digital currency exchange platform. In some cases, the digital currency exchange platform may be configured to provide real-time exchange rates between the monetary value and the Helium Network Tokens.

At step 604, transactions may be initiated for one or more network operator domains. In some cases, the initiation of the transactions may be verified before being initiated and/or settled. For example, the verifying may include comparing the initiated transactions with a predetermined threshold.

At step 606, one or more interactions with a blockchain network (e.g., the Helium blockchain, Solana, or the like) may be performed, in order to manage one or more corresponding transaction settlements in a settlement management domain. For example, the interactions with the blockchain may further include interacting with the blockchain using a blockchain interface that may monitor the settlement of transactions by one or more network operator domains (e.g., cellular network operator domains).

At step 608, transaction records for the network operator domains may be maintained in a settlement management domain. In some cases, the maintaining of the transaction records may further include updating the transaction records in real-time.

At step 610, transactions may be recorded and settled through the blockchain. For example, each of the transactions may be recorded and settled in a distributed ledger of the blockchain.

At step 612, the method may include facilitating network operator provisioning, transaction initiation, and/or settlement. In some cases, the facilitating of the network operator provisioning may further include registering a network operator with a first operator domain. Additionally or alternatively, the facilitating of transaction initiation may further include receiving a transaction request from the network operator and deducting a corresponding amount of Helium Network Tokens from an account of the network operator.

A number of implementations have been described. Nevertheless, it will be understood that various modifications may be made without departing from the spirit and scope of the disclosure. Accordingly, other implementations are within the scope of the following claims.

What is claimed is:

1. A system for recording and settling transactions in a wireless network environment using blockchain technology, comprising:
a plurality of network operator domains, wherein each of the plurality of network operators domains comprise network infrastructure components;
a first operator domain of the plurality of network operator domains, wherein the first operator domain comprises a gateway for managing device connections and a blockchain interface for managing transaction settlements; and
a settlement management domain for maintaining transaction records for the first operator domain, wherein the system interacts with a blockchain that is configured to record and settle transactions associated with data usage for the first operator domain, and wherein the system is configured to facilitate network operator provisioning, transaction initiation, and settlement.

2. The system of claim 1, wherein the wireless network environment is a broadband wireless network environment.

3. The system of claim 1, wherein the gateway is configured to manage device connections using at least one of WiFi, 4G, 5G, or 6G technologies.

4. The system of claim 1, wherein the blockchain interface in the first operator domain is configured to interact with the blockchain for real-time settlement of transactions.

5. The system of claim 1, wherein the settlement management domain maintains the transaction records for the first operator domain using a Settlement Service API to facilitate real-time reporting and settlement verification.

6. The system of claim 1, wherein the blockchain is configured to ensure secure and transparent settlement of transactions.

7. The system of claim 1, wherein the system is further configured to facilitate network operator provisioning through a network operator portal.

8. The system of claim 1, wherein the system is further configured to facilitate transaction tracking for each network operator.

9. The system of claim 1, wherein the system is further configured to facilitate settlement management through a Settlement Management Application Programming Interface (API).

10. The system of claim 1, wherein the system is further configured to facilitate the allocation of transaction records to a state channel in the blockchain.

11. A method for settling transactions in a wireless network environment, comprising the steps of:
converting monetary value into a digital currency;
initiating transactions for a first operator domain;
interacting with a blockchain through a blockchain interface to manage transaction settlements;
maintaining transaction records for multiple network operators in a settlement management domain;
recording and settling transactions through the blockchain; and
facilitating network operator provisioning, transaction initiation, and settlement.

12. The method of claim 11, wherein the wireless network environment is a broadband wireless network environment.

13. The method of claim 11, wherein the step of converting monetary value into digital currency comprises using a digital currency exchange platform.

14. The method of claim 13, wherein the digital currency exchange platform is configured to provide real-time exchange rates between the monetary value and the digital currency.

15. The method of claim 11, further comprising the step of verifying the initiation of transactions for the first operator domain, and wherein the step of verifying the initiation of transactions comprises comparing the initiated transactions with a predetermined threshold.

16. The method of claim 11, wherein the step of interacting with the blockchain through the blockchain interface comprises monitoring the settlement of transactions by the network operators.

17. The method of claim 11, wherein the step of maintaining transaction records for multiple network operators in a settlement management domain comprises updating the transaction records in real-time.

18. The method of claim 11, wherein the step of recording and settling transactions through the blockchain comprises recording each transaction in a distributed ledger of the blockchain.

19. The method of claim 11, wherein the step of facilitating network operator provisioning comprises registering the network operator with the first operator domain.

20. The method of claim 11, wherein the step of facilitating transaction initiation comprises receiving a transaction request from the network operator and deducting the corresponding amount of digital currency from the network operator's account.
